(19) United States
(12) Patent Application Publication
(10) Pub. No.: US 2006/0093442 A1
(43) Pub. Date: May 4, 2006

(54) Powder pump flow monitoring method and system

(76) Inventors: Ulf Kleineidam, Hamberg (DE); Andreas Kleineidam, Elmshorn (DE)

Correspondence Address: CALFEE, HALTER & GRISWOLD, LLP, 800 SUPERIOR AVENUE, SUITE 1400, CLEVELAND, OH, 44114, US

(21) Appl. No.: 11/261,088

(22) Filed: Oct. 28, 2005

(30) Foreign Application Priority Data
Oct. 29, 2004 (DE) 102004052949.3

(51) Int. Cl. B65G 51/08

(52) U.S. Cl. 406/10

(57) ABSTRACT

The invention concerns a method and a device for monitoring flow conditions in a pipe system (28), into which a mixture of pulverulent material and compressed conveying air is admitted from a feed pump (2) by alternately filling at least two chambers (10, 12) of the feed pump (2) with pulverulent material and then alternately emptying the chambers into the pipe system (28) by feeding compressed conveying air from a compressed air source (48) into one of the previously filled chambers (10, 12). To detect fluctuations in the flow conditions and especially to detect obstructions within the pipe system (28) and in this way to allow continuous process monitoring, the invention proposes that the flow rate of the compressed conveying air be measured and analyzed in a common compressed air feed line (70) leading from the compressed air source (48) to the two chambers (10, 12).

### RELATED APPLICATIONS

The present application claims priority to German Patent Application Number 102004052949.3, filed Oct. 29, 2004, which is fully incorporated by reference herein.

### BACKGROUND OF THE INVENTION

The invention concerns a method and a device for monitoring flow conditions in a pipe system in accordance with the introductory clause of claims 1 and 9.

So-called dense phase pumps are often used in powder coating installations to convey powder coating material by compressed air from a reservoir through a hose line to spray guns or other types of spray application devices, from which the coating material can then be sprayed onto the objects to be coated.

A dense phase pump of this type for the conveyance of powder coating material is described, for example, in DE 102 47 829 A1 and DE 102 61 053 A1 of the present applicant. The previously known pump has two parallel metering chambers, one of which is subjected to a negative pressure to draw powdered coating material into this chamber from the reservoir, while at the same time compressed conveying air is admitted into the other chamber to force the powder coating material previously drawn into the chamber into the hose line. The powder coating material is then conveyed by the compressed conveying air to the spray guns or other types of spray application devices in the form of successive “plugs”.

DE 199 59 468 A1 and EP 1 106 547 A1 also disclose dense phase pumps of this type, in which two or more metering chambers are alternately filled and emptied into a discharge pipe.

Since the spray guns are moved around the objects to be coated by the operating personnel during the powder coating operation to achieve uniform powder application, and the hose lines must be pulled along during this operation, kinks can sometimes develop in the hose lines, which can lead to obstruction of the lines due to the associated narrowing of the cross section. This causes an interruption or disruption of the work flow and makes it necessary to blow out the clogged lines, which results in wasted time and labor. Similar problems can also arise with automatic spray application devices if the hose lines leading to these devices are poorly installed.

The tandem pump described in DE 102 47 829 A1 and DE 102 61 053 A1 is also used in the manufacture of plastic and rubber tubes for the purpose of coating the inside of these tubes with powdered talc as a lubricant during their extrusion. The powdered talc is conveyed by the tandem pump through a pipe to a blast nozzle positioned in the center of the extrusion die and blown by the blast nozzle into the tube emerging from the extrusion die. The talc-bearing compressed conveying air flows through the entire length of the tube. If the tube becomes clogged with powdered talc in the vicinity of the extrusion die during this process, the obstruction travels away from the extrusion die at a high speed. If the operator of the extruder does not detect the obstruction quickly enough, it becomes necessary to cut large sections of the extruded tube out of the finished tube strand and to discard them as unusable.

Proceeding on the basis of this prior art, the objective of the invention is to develop a method and a device of the aforementioned type, with which fluctuations in the flow conditions and especially obstructions within the pipe system can be detected, so that continuous process monitoring is possible.

To achieve this objective, the invention proposes that a flowmeter be used to measure the flow rate of the compressed conveying air in a common compressed air feed line that leads to the two chambers from the compressed air source and that the measured flow rate be analyzed.

If the flow rate in the compressed air feed line drops at a constant pressure in the compressed air source, this is an indication of an increase in the flow resistance of the pipe system due to a reduction of the cross section. If the pipe system becomes completely obstructed, this manifests itself in an abrupt drop in the flow rate of the compressed air, since this type of obstruction generally occurs suddenly. In this regard, if the flow rate falls below a preferably adjustable threshold value, then, in a preferred embodiment of the invention, this is indicated to the operator by a warning signal, or, alternatively, the dense phase conveyance is interrupted by closing a valve in the compressed air feed line.

If the decrease in the flow rate or flow volume occurs more slowly and less sharply, the cause can be, for example, a gradual caking of pulverulent material on the inner walls of the pipe system, which can possibly be removed by increasing the pressure in the compressed air feed line. Therefore, in another preferred embodiment of the invention, the flowmeter is part of a closed-loop control system, which comprises mechanisms for varying the pressure or the flow rate in the compressed air feed line, so that the drop in flow rate can be counteracted by an increase in the pressure and/or the flow rate.

Furthermore, a very small drop in the flow rate or flow volume of the compressed air in the compressed air feed line can also be caused by a gradual decrease in the permeability of a particle filter, which is installed between each chamber and the compressed air feed line in the previously known pumps. The purpose of this particle filter is to prevent backflow of pulverulent material into the line when separate sections of the line between the chambers and a multiple-way control valve are alternately used as a compressed air feed line and a vacuum line for drawing pulverulent material into the chambers by applying a vacuum to the chambers. Therefore, in another advantageous embodiment of the invention, this gradual decrease is used to determine the optimum time for replacement of the particle filter.

The installation of the flowmeter in the common compressed air feed line in accordance with the invention has the advantage that compressed air flows through the flowmeter essentially continuously. Accordingly, the measurement and the analysis of the measured flow rate does not have to be interrupted while powder is being drawn into the chamber, since during this period, compressed air is being fed to the other chamber or to one of the other chambers. Furthermore, the installation of the flowmeter on the clean-air side can prevent contamination by the conveyed powder particles, which is unavoidable when the sensors are installed in the pipe system after the feed pump.

In another preferred embodiment of the invention, the flow rate of the compressed conveying air is measured upstream of a multiple-way control valve, which alternately connects the common compressed air feed line with the chambers and alternately connects each of the chambers with the compressed air source and a negative pressure source. In the case of a feed pump with two chambers operating in tandem, the multiple-way control valve is preferably a four-way or five-way control valve with two or three inlets and two outlets, such that one of the inlets is connected with the common compressed air feed line and the other inlet or the other inlets are connected with a vacuum line that leads to a negative pressure source, while each of the two outlets is connected with one of the two chambers.

In principle, the flow rate in the compressed air feed line can be measured by various measurement principles, for example, by the rotameter principle, in which a movable diaphragm plate or baffle plate in a tapered tube, through which the compressed air is flowing in the flowmeter, is more or less strongly deflected as a function of the flow rate, and its deflection is converted to an electric evaluation signal by a rotary potentiometer or the like. A flowmeter of this type has a relatively large lag time, so that a short-term drop in the flow rate that occurs during each switching of the control valve for a period of 2 to 3 milliseconds has no perceptible effects on the measured flow rate.

However, in another preferred embodiment of the invention, a flow meter or air volume meter that operates by the hot-wire or hot-film principle is used, which is very small and has no moving parts. Air volume meters that operate by this principle are well known in automotive engineering, where they are used to measure the intake air flow of internal combustion engines. Due to the rapid response behavior of flow meters or air volume meters of this type, preferably the flow rate measured in a short time interval of 5 to 10 milliseconds after the switching of the directional control valve is used for the analysis, so that the short-term drop in the flow rate during the switching of the valve does not affect the result of the analysis.

In another embodiment of the invention, the measured flow rate in the compressed air feed line can also be used to determine the amount of powder conveyed through the pipe system, for example, by analysis of input-output maps, in which is stored the given amount of powder conveyed through the pipe system per unit time as a function of the measured flow rate and other operating parameters of the feed pump.

The invention is explained in greater detail below with reference to the embodiment of the invention illustrated in the drawings.

### BRIEF DESCRIPTION OF THE DRAWINGS

FIG. 1 shows a top view of a device for the pneumatic conveyance of powder coating material by the dense phase process with two metering chambers.

FIG. 2 shows a partially cutaway and somewhat schematic view of the device of FIG. 1.

FIG. 3 shows an enlarged longitudinal section of part of one of the two metering chambers of the device.

FIG. 4 shows a simplified pneumatic circuit diagram of part of the device.

FIG. 5 shows a view of a flowmeter of the device.

FIG. 6 shows a sectional view of a preferred negative pressure source.

### DETAILED DESCRIPTION OF THE PREFERRED EMBODIMENTS

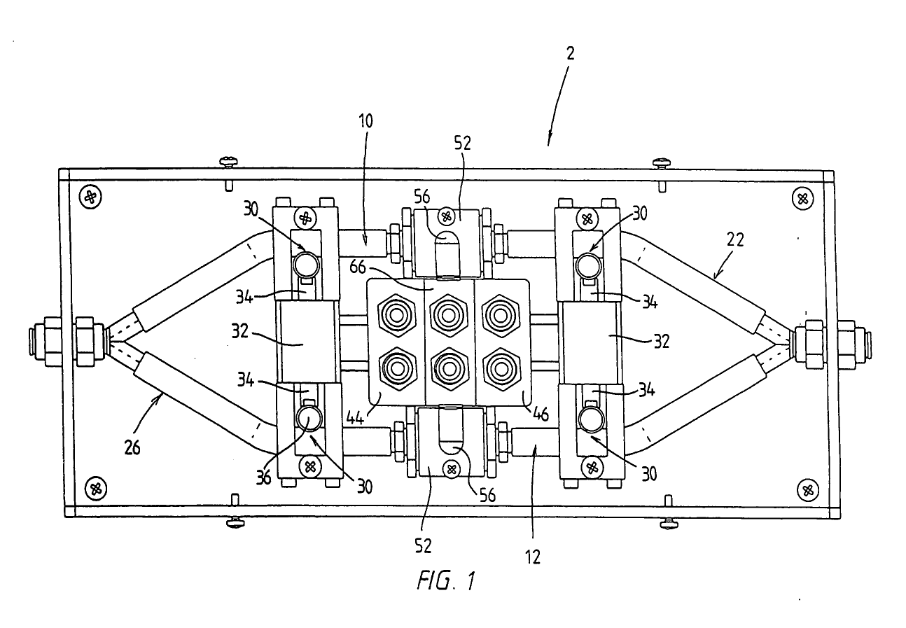

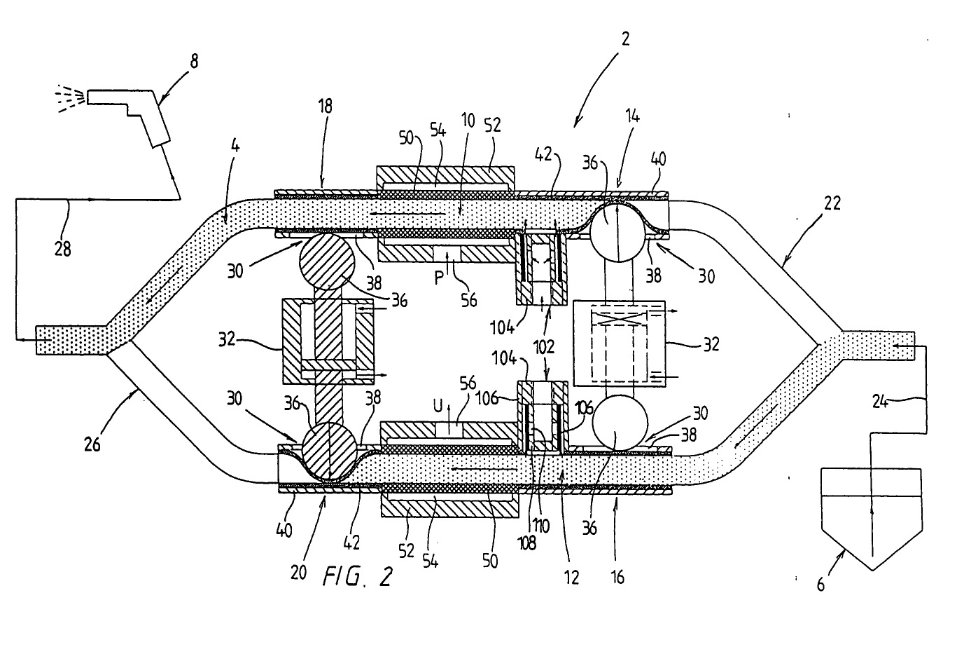

The device 2 shown in the drawings of FIGS. 1 and 2 is used for the pneumatic conveyance of powder coating material for the electrostatic powder coating of objects in a powder coating installation. The powdered coating material is conveyed in dense phase from a reservoir 6 to a spray gun 8. Alternatively, however, the device shown in FIGS. 1 and 2 can also be used in the extrusion of plastic or rubber tubes for the purpose of conveying powdered talc by means of compressed air from a reservoir to an extrusion die (not shown), through which the mixture of powdered talc and compressed air is fed into the inside of a tube that has just been extruded in order to coat the inside surface of the tube with the powdered talc to reduce friction.

As is shown best in FIG. 2, the device 2 has two parallel cylindrical metering chambers 10, 12, whose oppositely open ends form an inlet 14, 16 or an outlet 18, 20 for the powder coating material 4 that is being conveyed and are connected with a Y-shaped section 22 of a feed line 24 leading to the reservoir 6 and with a Y-shaped section 26 of a flexible delivery line 28 leading to the spray gun 8.

Each of the two metering chambers 10, 12 can be closed near its inlet 14, 16 and its outlet 18, 20 by a pinch valve 30. The pinch valves 30 for the two inlets 14, 16 and the pinch valves 30 for the two outlets 18, 20 are operated by two double-acting pneumatic cylinders 32 located between the two metering chambers 10, 12. Each of the two pneumatic cylinders 32 has two piston rods 34, which extend from opposite ends. Their spherically rounded free ends 36 at the inlet 14, 16 or the outlet 18, 20 engage an elastically deformable, pliable inner wall section 42 of the chamber 10, 12 through recesses 38 in a rigid cylindrical outer wall section 40 of the adjacent metering chamber 10, 12. This presses the inner wall section 42 against an opposite part of the chamber wall and seals the inlet 14, 16 or the outlet 18, 20 airtight. Except in the area of the recesses 38, the elastic inner wall sections 42 are firmly connected with the rigid sections of the outer wall to prevent them from contracting when a negative pressure is applied in the chamber 10, 12.

The two pneumatic cylinders 32 are each connected by an electromagnetic multiple-way control valve 44, 46 (FIG. 1) with a compressed air tank 48 (FIG. 4). During the conveyance operation, the two control valves 44, 46 are always operated in such a way that the pneumatic cylinders 32 are acted upon crosswise by compressed air, so that in one chamber 10, the inlet 14 is open and the outlet 18 is closed, while in the other chamber 12, the inlet 16 is closed and the outlet 20 is open, or vice versa (as shown in FIG. 2).

To allow powder coating material 4 to be drawn from the reservoir 6 into the chamber 10 or 12 with the open inlet 14 or 16 and to be discharged from the chamber 12 or 10 and into the delivery line 28 with the outlet 20 or 18 open, the two chambers 10, 12 are each provided with a hollow-cylindrical filter element 50, which is permeable to air and impermeable to the powder coating material 4. This filter element 50 borders on the chamber 10, 12 between its inlet 14, 16 and its outlet 18, 20 along part of its length in the circumferential direction and forms a section of the circumferential wall of the chamber 10, 12.

The hollow-cylindrical filter element 50 consists of sintered polyethylene with a wall thickness of 2-4 mm and a pore size of about 5 μm and has an inside diameter of 5-30 mm, which basically corresponds to the inside diameter of the adjoining wall sections 40, 42 on either side, the Y-shaped sections of lines 22 and 26, and the feed line 24 and the delivery line 28. The filter element 50 extends along about half the length of the chamber (measured between the centers of the pinch valves 30), and it is advantageous for it to have a length of 20-70 mm. At its two end faces, the filter element is connected airtight with the adjoining sections 40, 42 of the circumferential wall.

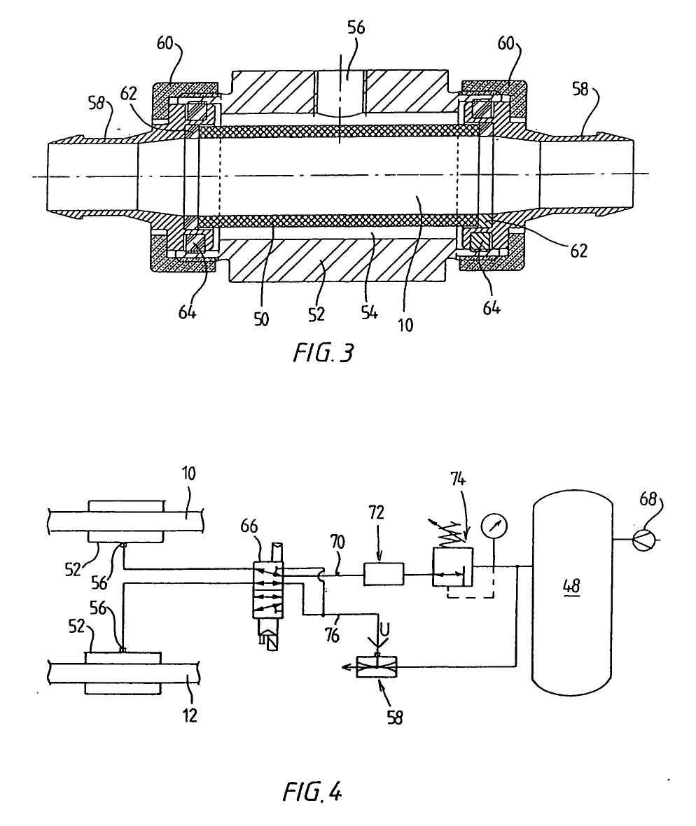

As is shown best in FIG. 3, each filter element 50 is surrounded by a housing 52, which is separated from the filter element 50 by a cylindrical annular space 54 and has a connection 56, which can be alternately acted upon by negative pressure from a negative pressure source 58 (FIG. 4) and by compressed air from the compressed air tank 48. At the two opposite end faces of the housing 52 and the filter element 50, there is a hose connection 58, onto which the adjoining elastically pliable circumferential wall section 42 can be pushed and fastened by hose clips (not shown). The hose connections 58 are screwed together with the housing 52 by screw caps 60. Gaskets 62, 64 inserted between the hose connections 58 and the filter element 50 and the housing 52 prevent compressed air from escaping from the chamber 10, 12 or from the annular space 54 of the housing 52 in this region when compressed air is admitted to the chamber 10, 12 and prevent outside air from entering the chamber 10, 12 or the annular space 54 when negative pressure is applied to the chamber 10, 12.

As is shown best in FIG. 4, the compressed air/negative pressure connection 56 on the housing 52 of each metering chamber 10, 12 is alternately connected by an electromagnetic 5-way control valve 66 with the negative pressure source 58 and with the compressed air tank 48 to apply negative pressure to the given chamber 10, 12 to draw powder coating material 4 out of the reservoir 6 with the inlet 14 or 16 open and the outlet 18 or 20 closed and to feed compressed air into the chamber 10, 12 to discharge the powder coating material 4 previously drawn into the chamber 10, 12 with the inlet 14 or 16 closed and the outlet 18 or 20 open and convey it through the delivery line 28 by the dense phase or so-called plug flow method.

The compressed air tank 48, which can be filled with compressed air by a compressor 68, is connected with one of the three inlets of the 5-way control valve 66 via a compressed air feed line 70. A flowmeter 72 is inserted in the compressed air feed line 70 between a pressure regulator 74 and the 5-way control valve 66. The other two inlets of the 5-way control valve 66 are connected by a line 76 with the negative pressure source 58, which is designed as a vacuum injector.

Instead of a 5-way control valve, a 4-way control valve could also be used, which has two inlets, one of which is connected with the compressed air tank 48 via the flowmeter 72 and the pressure regulator 74, and the other is connected with the negative pressure source 58, while each of the two outlets is connected with one of the two chambers 10, 12, so that the chambers are alternately acted upon by compressed air and negative pressure with each switching of the valve.

At the same time that the 5-way control valve 66 is being switched, the two multiple-way control valves 44, 46 (FIG. 1) in the compressed air feed lines of the pneumatic cylinders 32 are also being switched, in order to close the outlet 18 or 20 and open the inlet 14 or 16 of the chamber 10 or 12 that has just been emptied and to close the inlet 16 or 14 and open the outlet 20 or 18 of the chamber 12 or 10 that has just been filled.

As FIG. 5 shows, the air volume meter or flowmeter 72 consists essentially of a housing 78 that can be inserted airtight in an opening in the wall of the compressed air feed line 70 and a hot-wire element 80 that projects from the housing 78 into the interior of the compressed air feed line 70 and that can be connected with a source of heating current 86 via external connections 82 and an ammeter 84 connected to an analysis circuit 88. The hot-wire element 80 comprises a filamentary platinum heating resistor 90, which, together with a temperature-measuring resistor, a sensor resistor and a rheostat (not shown in detail), forms a bridge circuit, which is applied as a thin film on the surface of a ceramic substrate 92, around which the compressed conveying air flows. During the operation of the flowmeter 72, the bridge circuit is adjusted in such a way that a constant temperature difference between the heating resistor 90 and the temperature-measuring resistor is maintained. Since the compressed conveying air flowing past the hot-wire element 80 cools the heating resistor 90, the current supplied to the heating resistor 90 to maintain this temperature difference must be increased with increasing air flow volume and thus increasing cooling of the heating resistor 90, since the temperature-measuring resistor remains unaffected by the volume of the air flow. The current supplied to the heating resistor 90 is measured by the ammeter 84 and then analyzed in the analysis circuit 88. In this regard, the analysis is based on the current measured about 10 milliseconds after the switching of the 5-way control valve 66. This prevents the drop in the air volume flow due to the switching of the 5-way control valve 66, which takes about 3 milliseconds, from affecting the measured flow rate. Furthermore, if the measured current is always measured with a constant time delay after the switching of the 5-way control valve 66, it is possible to avoid a possible slight effect on the flow rate by different amounts of powder in the chamber 10, 12.

A sudden drop in the measured voltage, i.e., a drop below a preset threshold value of the current, is interpreted by the analysis circuit 88 as an obstruction in the hose line 28 or in one of the line sections 26. This obstruction can be indicated to the operator of the spray gun 8 by a warning signal, or the admission of compressed air into the chambers 10, 12 and the application of negative pressure to the chambers 10, 12 are interrupted by closing shutoff valves (not shown) in lines 70 and 76 until the obstruction has been removed. Alternatively, however, the flowmeter 72 can also be part of a closed-loop control system (not shown), which, in the event of a sudden drop in the measured current, removes the obstruction by temporarily increasing the pressure in the line 70 with the aid of the pressure regulator 74. In this regard, a warning signal can first be emitted to warn the operator of the spray gun 8 of the impending pressure increase, so that the spray jet can be temporarily directed away from the object to be coated.

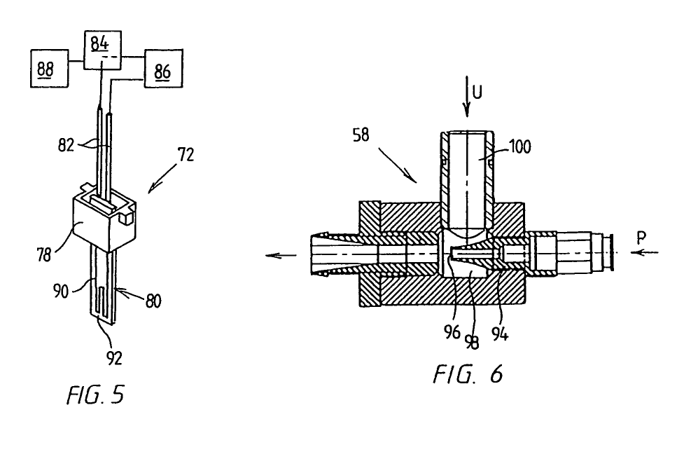

As is shown best in FIG. 6, the vacuum injector 58 has an injector nozzle 94, which is supplied with compressed air P from the compressed air tank 48. During the feeding of compressed air into the injector nozzle 94, a negative pressure is produced by the venturi principle in an annular space 98 surrounding the outlet 96 of the injector nozzle 94. This negative pressure is applied via a connecting socket 80 and the line 76 to the two inlets of the 5-way control valve 66 that are connected with the negative pressure source 58 and, with each switching of the 5-way control valve 66, is alternately applied to one of the two chambers 10, 12, while, at the same time, the other chamber 12, 10 is being supplied with compressed air.

As is shown best in FIG. 2, the application of a negative pressure U with the inlet 16 open causes powder coating material 4 to be drawn from the reservoir 6 and the feed line 24 into one of the chambers 12, while the compressed air P fed into the other chamber 10 through the filter element 50 forces the powder coating material 4, which had previously been drawn into this chamber 10, through the outlet 18 and through one of the arms of the Y-shaped section of line 26 into the delivery line 28. To ensure conveyance that is as frictionless as possible without large pressure losses, the Y-shaped section of line 26 and the Y-shaped section of line 22 are bent at an angle of less than 30° at each of their bending points, i.e., at the connecting points between the leg and the two arms of the Y and between each arm and the inlet 14, 16 of the corresponding chamber 10, 12.

The compressed air fed into the given chamber 10, 12 during conveyance through the filter element 50 not only forces the powder coating material 4 present in the chamber 10, 12 into the delivery line 28, but also cleans the cylindrical inside surface of the filter element 50 of adhering powder coating material 4, which had previously been drawn onto this surface by the previously applied negative pressure. It was found, however, that the pressure surge produced inside the chamber 10, 12 by the admission of compressed air into the chamber 10, 12 is not always sufficient also to clean the remaining inner surfaces of the chamber 10, 12 and the filter element 50 of powder particles, since the powder particles can adhere relatively strongly to these surfaces due to a triboelectric charge. To be sure, to clean a metering chamber, for example, chamber 10, it is basically possible, by suitable switching of the multiple-way control valves 44, 46 of the pneumatic cylinders 32, to open both the inlet 14 and the outlet 18 of this chamber 10 (and to close the inlet 16 and the outlet 20 of the other chamber 12), and then to blow out this chamber 10, together with the delivery line 26 and the feed line 24, from the reservoir 6 or from the spray gun 8.

However, since this manner of cleaning the entire pipe system is not always desired, the two chambers 10, 12 are each equipped with an additional cleaning valve 102 (FIG. 2), through which compressed air can be blown into the interior of the chamber 10, 12 to clean the chamber. The cleaning valve 102, which opens radially into the chamber 10, 12 from the side between the filter element 50 and the inlet 14, 16 (or the outlet 18, 20), consists essentially of a metallic pipe nipple 104 with an annular cross section, which is screwed airtight, by means of an external thread on its thicker end facing away from the chamber 10, 12, into an internally threaded bore of a pipe socket 88 that projects above the chamber wall 42, and whose thinner end facing the chamber 10, 12 is closed at its end face and has several radial drill holes 110 in the wall 108 of its cylindrical surface. A diaphragm in the form of a hose coupling 106 made of an elastic rubber material is fastened on the thinner end of the pipe nipple 104. The diaphragm rests loosely against the outer peripheral surface of the pipe nipple 104 under tensile force and seals the drill holes 110, as shown at the bottom in FIG. 2. During the admission of compressed air into the cleaning valve 102, the diaphragm 106 is lifted from the outer peripheral surface of the nipple 104 by the compressed air, so that the compressed air can flow between the diaphragm 106 and this peripheral surface and into the chamber 10, as shown at the top of FIG. 2. Upon completion of the admission of compressed air, the deformed diaphragm 106 moves back against the peripheral surface of the nipple 104 due to its elastic restoring force and prevents powder coating material 4 from escaping through the cleaning valve 102 when compressed air is later admitted into the chamber 10, 12.

However, despite regular cleaning, the pores of the filter element 50 cannot be prevented from gradually becoming clogged with fine dust on the inner surface of the filter element 50 that faces the chambers 10, 12. This fine dust penetrates the pores and can no longer be completely removed, despite the admission of compressed air or cleaning air into the filter element 50. For this reason, the filter element 50 must be replaced at regular intervals. The optimum time for replacement of the filter element 50 can also be determined with the aid of the flowmeter 72 by taking the average of the flow rates over predetermined intervals of time and comparing the mean values over a longer period of time by means of the analysis circuit. This comparison shows a slow, steady decrease in the measured flow rates due to the gradual decrease in flow volume that results from the slow clogging of the filter element 50, and the optimum time for replacing the filter element 50 can be calculated on this basis.

1. A method for monitoring the flow conditions of a mixture of a pulverulent material and compressed conveying air from a feed pump, the method comprising:
alternately filling at least two chambers of the feed pump with pulverulent material;
feeding compressed conveying air from a compressed air source into the chamber that was filled earlier to empty the pulverulent material from the pump;
generating a signal relating to the flow of the compressed conveying air an air line that leads from the compressed air source to at least one of the two chambers.

2. The method in accordance with claim 1 wherein the flow rate of the compressed conveying air is measured before a multiple-way control valve in the direction of flow of the compressed air, which valve alternately connects the compressed air feed line with the chambers.

3. The method in accordance with claim 2 wherein the the flow rate is measured with a predetermined time delay after each switching of the multiple-way control valve.

4. The method in accordance with claim 1 further comprising the step of emitting a signal when the measured flow falls below a predetermined threshold value.

5. The method in accordance with claim 1 further comprising the step of increasing the pressure of the compressed conveying air supplied to the chambers when a drop in the measured flow occurs.

6. The method in accordance with claim 1 further comprising the step of using the measured flow to determine the amount of powder conveyed through the pipe system per unit time.

7. The method in accordance with claim 1 further comprising the step of using the measured flow to determine the time for replacement of a filter element installed in the flow path of the compressed conveying air in front of each chamber.

8. The method in accordance with claim 1 wherein the flow rate is measured with a hot-wire or hot-film flowmeter.

9. A system for monitoring the flow conditions of a mixture of a pulverulent material and compressed conveying air, the system comprising:
a compressed air source;
a feed pump having at least two chambers, which can be alternately filled with pulverulent material and then acted upon by compressed conveying air from the compressed air source to empty the chambers from the pump by feeding compressed conveying air into the chamber that was filled earlier;
a device installed in communication with a compressed air feed line that leads from the compressed air source to at least one of the chambers;
wherein the device generates a signal corresponding to a characteristic of the compressed air flowing through the compressed air line.

10. The system in accordance with claim 9 further comprising a multiple-way control valve installed after the device in the direction of flow of the compressed air, wherein the valve alternately connects the compressed air feed line with the chambers.

11. The system in accordance with claim 10 wherein the device analyzes the flow rate that is measured with a predetermined time delay after each switching of the multiple-way control valve.

12. The system in accordance with claim 10 wherein at least one inlet of the multiple-way control valve is connected to a negative pressure source.

13. The system in accordance with claim 10 wherein the device is installed between the multiple-way control valve and a pressure regulator in the direction of flow of the compressed conveying air.

14. The system in accordance with claim 9 wherein the device is part of a closed-loop control system for varying the pressure of the compressed conveying air in the compressed air feed line.

15. The system in accordance with claim 9 further comprising an alarm for emitting a signal if the flow rate falls below a predetermined threshold.

16. The system in accordance with claim 9 further comprising a control element for interrupting the conveyance when the flow rate falls below a predetermined threshold value.

17. The system in accordance with claim 9 further comprising a flow meter for determining the amount of powder conveyed through the pipe system on the basis of the measured flow rate.

18. The system in accordance with claim 9 wherein the device is an air volume meter.

19. The system in accordance with claim 9 wherein the device is a hot-wire or hot-film air volume meter.

20. (canceled)

21. The method in accordance with claim 1 further comprising interrupting the conveyance through the pipe system when the measured flow rate falls below a predetermined threshold value.

22. The method in accordance with claim 1 further comprising increasing the volume of the compressed conveying air supplied to the chambers when a drop in the measured flow rate occurs.

23. The device in accordance with claim 9 wherein the device is part of a closed-loop controller for varying the flow rate of the compressed conveying air in the compressed air feed line.

24. The system in accordance with claim 9 further comprising an indicating element for indicating the time for the replacement a filter element installed in the flow path of the compressed conveying air in front of each chamber.
